(19) United States
(12) Patent Application Publication
(10) Pub. No.: US 2026/0179975 A1
(43) Pub. Date: Jun. 25, 2026

(54) SEPARATOR PLATE

(71) Applicant: Reinz-Dichtungs-GmbH, Neu-Ulm (DE)

(72) Inventors: Bernadette GRUENWALD, Ulm (DE); Claudia KUNZ, Ulm (DE)

(21) Appl. No.: 19/427,868

(22) Filed: Dec. 19, 2025

(30) Foreign Application Priority Data
Dec. 20, 2024 (DE) 20 2024 107 472.6

(51) Int. Cl. H01M 8/0258; C25B 11/036; C25B 13/02; H01M 8/0276

(52) U.S. Cl. CPC H01M 8/0258; C25B 11/036; C25B 13/02; H01M 8/0276

(57) ABSTRACT

The present disclosure relates to a separator plate separator plate for an electrochemical system, comprising a bead arrangement and at least one conduit channel for directing a fluid, wherein the conduit channel connects to the bead arrangement and is fluidically connected to a bead interior of the bead arrangement, and has a channel roof, a channel base and two channel flanks extending between the channel roof and the channel base, wherein a base width of the channel base, determined parallel to the plane of the separator plate, increases towards the bead arrangement at least in a section of the conduit channel, while a channel roof width of the channel roof, determined parallel to the plane of the separator plate, decreases towards the bead arrangement in said section, so that a cross-sectional shape of the conduit channel changes.

### CROSS REFERENCE TO RELATED APPLICATION

This application claims priority to German Utility Model Application No. 20 2024 107 472.6, entitled “SEPARATOR PLATE”, filed Dec. 20, 2024. The entire contents of the above-identified application is hereby incorporated by reference for all purposes.

### TECHNICAL FIELD

The present disclosure relates to a separator plate, in particular a separator plate for an electrochemical system. Such electrochemical systems include flow batteries, electrochemical compressors, fuel cells and electrolyzers.

### BACKGROUND AND SUMMARY

In fuel cells, for example, a large number of such separator plates are stacked individually or in pairs perpendicular to the separator plate plane. The pairs of separator plates will hereinafter also be referred to as bipolar plates. The individual bipolar plates or separator plates are usually spaced apart from each other by means of intermediate layers, for example membranes or membrane electrode assemblies (MEAs).

A membrane electrode assembly (MEA) usually has an electrochemically active region in which proton transfer takes place between the two sides of the MEA and in which electrodes and catalytic coatings are present on the membrane surfaces. Outside the electrochemically active region, the MEAs are usually surrounded by a reinforcing edge, which often surrounds the electrochemically active region in the form of a frame. At least in the electrochemically active region, a gas diffusion medium is usually also present on each surface, which makes it easier for oxygen and hydrogen to access the coated membrane.

For the sake of simplification, in relation to the separator plates, the terms electrochemically active region and electrochemically inactive region will be used below even when referring to the regions situated opposite these regions of the MEA.

These separator plates have seals to separate fluid-carrying spaces from each other and from the external environment. Bead arrangements that are molded directly into the separator plates are often used to this end. However, a fuel cell seal usually consists of more than just a bead arrangement. Rather, this can be supplemented by micro-seals, such as elastomer-based sealing elements, for example foamed elastomer-based sealing elements, such as those known from DE 10 2021 204 497 A1 of the applicant. These can be applied as a coating to the bead arrangement, for example to the bead roof itself, or to the MEA, as in the aforementioned document. Typically, bead arrangements in metallic separator plates are designed as full beads. So-called balconies and, where applicable, distribution channels can also be regarded as bead arrangements; balconies have a half-bead shaped cross-section, while distribution channels have a full-bead shaped cross-section, at least in some sections of their course.

In the case of full beads, the bead arrangement-when viewed in cross-section transverse to the longitudinal extension of the bead arrangement-with its usually centrally arranged bead roof protrudes furthest out of the separator plate plane adjacent to both sides of the bead arrangement. Adjacent to this bead roof on both sides is a bead flank, which guides down the protrusion of the bead roof to the separator plate plane again. In the region of the tangential transition to the separator plate plane, there is in each case a bead foot on the side of a respective bead flank that faces away from the bead roof.

Half beads form an offset (cranking) of the separator plate plane in a layer-when viewed in cross-section transverse to the longitudinal extension of the bead arrangement. The transition between the neighboring separator plate planes is called the bead flank, which is connected to a bead foot on both sides. One of the bead feet of the half bead can also be referred to as a bead roof.

In particular, the bead arrangements in the separator plates can be sealing beads that seal fluid-conducting spaces between separator plates and neighboring MEAs in a fluid-tight manner. For sealing beads, a distinction can be made between port beads, i.e. beads surrounding through openings, and perimeter beads, i.e. sealing beads located towards the outer edge.

Bead-shaped conduit channels are used to create channel-like recesses in the separator plates into which fluids, for example reactants such as hydrogen or oxygen or air or coolants, are fed.

Such conduit channels can also be used, particularly outside the electrochemically active region, to guide fluids through sealing beads, so-called passages, so that two of these conduit channels form intersections with the bead arrangements. Hereinbelow, the term “intersection” is to be understood not necessarily as a crossing at right angles but rather can also encompass a crossing at other angles. Similar to full beads, such conduit channels can also have a roof, which is adjoined on both sides by a flank with which the protrusion of the roof of the conduit channel is guided back to the separator plate plane. In the region of the tangential transition to the separator plate plane, there is a base of the conduit channel on the side of a flank that faces away from the roof.

Furthermore, bead-shaped protrusions can also be used as support elements, for example adjacent to the edge of the electrochemically active region. For example, they run transversely to a bead arrangement and serve to support the reinforcing edge of the MEA. The support elements, which open into the flanks of the adjacent bead arrangement, if they are of a suitable height and width also serve to prevent the penetration of media into the space between the electrochemically active region and the bead arrangement. These support elements that open into the bead arrangement are also considered to be conduit channels in the following, even if the fluid guidance task of these conduit channels is to hold back fluid.

Depending on the course of the bead arrangements and the proximity of or intersection with neighboring conduit channels or support elements, these bead arrangements have softer or stiffer regions along their course, with their design being otherwise identical. For example, bead arrangements in intersection regions with passages are geometrically stiffer, at least in sections, than those that are located away from passages. Passages therefore conventionally lead to an uneven compression of the bead arrangement over its course. The same applies to the openings of support elements, which are also considered to be conduit channels, in the flanks of bead arrangements. The micro-seals can largely compensate for the unevenness, but uneven bead compressions are still disadvantageous for reliable sealing and sufficient durability of the bead arrangements.

One particular disadvantage is that, in the case of such uneven bead compression, the spring deflection of the bead as a whole is lower than in the case of even bead compression, thereby adversely affecting the sealing behavior of the bead.

Attempts have already been made to achieve a uniform bead pressure by means of geometric adjustments to the conduit channels. Until now, however, this has only been possible by significantly increasing the pressure loss of the transported media, which results in an insufficient media supply or has to be compensated for by increasing the pressure of the media supply, both of which are unfavorable or even unacceptable.

It is therefore the object of the present disclosure to at least partially solve the above problems. It would be advantageous, for example, to provide a separator plate in which the bead compression is specifically influenced, for example equalized, without significantly increasing the pressure loss of the transported media.

This object is solved by the subject-matter described herein.

According to one aspect, a separator plate for an electrochemical system is provided. The separator plate comprises a bead arrangement and at least one conduit channel for directing a fluid. The conduit channel connects to the bead arrangement and is fluidically connected to a bead interior of the bead arrangement. The conduit channel has a channel roof, a channel base and two channel flanks extending between the channel roof and the channel base.

More precisely, the conduit channel has a base width of the channel base that is determined parallel to the separator plate plane of the separator plate and a channel roof width of the channel roof that is also determined parallel to the separator plate plane of the separator plate, wherein the base width increases towards the bead arrangement, at least in one section of the conduit channel, while the channel roof width decreases towards the bead arrangement in said section. This changes the cross-sectional shape of the conduit channel from the end of the conduit channel that faces away from the bead to the bead arrangement.

By reducing the width of the channel roof in the direction of the bead flank, the surface and line compression of the bead arrangement is clearly evened out over its course, as will be shown below. At the same time, the opposite change in the widths of the channel roof and channel base of the at least one conduit channel does not result in significantly higher pressure drops in the conduit channel compared to conventional conduit channels, which would lead to unacceptably uneven bead compressions.

Such an arrangement can concern guidance of a reaction fluid such as a gas guide, but also the coolant guidance.

For example, the transition to a protrusion/balcony or the transition to a distribution channel can represent the end of the conduit channel that faces away from the bead. In the case of coolant routing, the end of the conduit channel that faces away from the bead can be located at the transition to the coolant-carrying cavity. In all the aforementioned cases, the end of the conduit channel advantageously begins at the start of a corresponding transition radius on the conduit channel side. On the other hand, the relevant section of the conduit channel can extend up to the bead flank and thus end in a slope. This can result in different extension lengths of the channel roof and the channel base along the aforementioned section.

Advantageously, the channel roof of the conduit channel has its smallest channel roof width directly at the bead arrangement. For example, the ratio of the channel roof width to the base width can be less than 0.2, for example less than 0.1 or even less than or equal to 0.05, directly at the bead arrangement. Slight deviations from a perfect triangular shape with a point-shaped “roof”, are therefore permitted. The channel roof width directly at the bead arrangement, like the base width, can be determined orthogonally to the direction of the conduit channel at the point where at least one foot of the channel begins to merge into a foot of the bead in the direction of the channel towards the bead. At the end of the conduit channel that faces away from the bead, on the other hand, the ratio of channel roof width to base width can be at least 0.3 and/or at most 0.8. The ratio is also influenced by the radii with which the channel flanks merge into the channel roof or the channel base. Larger radii usually result in smaller ratios, smaller radii in larger ratios.

A particularly advantageous embodiment results if the cross-sectional shape of the conduit channel directly at the bead arrangement is essentially triangular, while the cross-sectional shape of the conduit channel is essentially trapezoidal in a region of the conduit channel at a distance from the bead arrangement and in the afore-mentioned section. In this context, “essentially triangular” and “essentially trapezoidal” are to be understood in particular as meaning that the material of the conduit channel spans triangular or trapezoidal cross-sections that are provided with radii. For example, the radii can be 0.08 mm to 0.5 mm.

A first advantageous variant is that the conduit channels are designed with mirror symmetry. The channel flanks can have the same flank length directly at the bead arrangement. The flank angles of the two channel flanks are often also the same when measured against the separator plate plane directly at the bead arrangement. The above properties are usually associated with the fact that the center lines of the channel roofs of at least two conduit channels have a straight course. The channel roofs of at least two conduit channels often run parallel to each other. At least one, and optionally at least two, of the conduit channels extend at least partially perpendicular to a main direction of extension of the bead arrangement.

An alternative advantageous variant is that the conduit channels are designed asymmetrically. The center lines of the channel roofs of one or more conduit channels can be curved or straight. The channel flanks directly at the bead arrangement can have different flank lengths. The flank angles between the two channel flanks and the separator plate plane that are measured directly at the bead arrangement often differ. The center lines of the channel roofs of at least two conduit channels, for example of two adjacent conduit channels, can run non-parallel to each other.

If the bead arrangement does not run in a straight line with respect to its main direction of extension, for example at an oval or round through opening, the center lines of the channel roofs can also not run parallel to each other, for example on axes running through the center of the through opening. In this case, however, the conduit channels can be designed with mirror symmetry in relation to the center lines of their channel roofs.

At least one conduit channel can extend at least partially perpendicular to a main direction of extension of the bead arrangement. In the case of a wave-shaped bead arrangement, the main direction of extension is to be understood as the direction that results when the amplitude of the waveform is reduced to zero.

Optionally, a size of the flow cross-section of the conduit channel remains essentially the same in the section in which the base width of the conduit channel increases towards the bead arrangement, while the channel roof width of the conduit channel decreases. For example, this means that the cross-sectional flow area does not change or changes only insignificantly in this section despite the changes to the geometry of the channel. For example, the flow cross-sectional area along the relevant section changes by less than 10%, optionally less than 5%.

It may also be advantageous if the height of the conduit channel or the distance of the channel roof from the separator plate plane in the section in which the base width of the conduit channel increases towards the bead arrangement, while the channel roof width of the conduit channel decreases, does not change or changes only insignificantly, i.e. by less than 10% or less than 5%. The height is measured in a direction perpendicular to the separator plate plane. A constant distance of the channel roof from the separator plate plane can be associated with the fact that the channel roof of the conduit channel runs flat and parallel to the separator plate plane.

The bead roof of the bead arrangement can also be flat and can extend at least along the bead cross-section, i.e. perpendicular to the main direction of extension of the bead, parallel to the separator plate plane. Alternatively, however, the bead roof of the bead arrangement can also have a cambered or wavy cross-section. In both variants, the cross-sectional shape can remain constant or change over the course of the bead, i.e. along the main direction in which the bead extends.

The height of the bead arrangement is optionally greater than the height of the conduit channel, for example by at least 50 μm. In the case of a cambered or wavy roof, at least the highest point of the bead cross-section is optionally further away from the separator plate plane than the center line of the channel roof. Optionally, the center line of the channel roof enters the bead flank in a region that is at a smaller distance from the separator plate plane than the bead roof or at least the highest point of the bead roof.

The transition from a channel flank to a bead flank can span a radius; it may be advantageous if a continuous radius is formed from the channel base to the channel roof, possibly even along the channel roof. The radii on both channel flanks can also be identical. For example, the radius is between 0.1 mm and 0.6 mm.

Optionally, a bead has more than just a single conduit channel along its course. In fact, a first group of conduit channels and a second group of conduit channels may be arranged on opposite sides of the bead arrangement.

The first group of conduit channels and the second group of conduit channels can be arranged in alignment with each other in the direction of flow of the fluid in the conduit channels, i.e. in the direction of extension of the conduit channels or transverse to the main direction of extension of the bead, for example completely aligned or only partially aligned, for example in the region of the channel bases. Alternatively, the conduit channels of the first group can be arranged perpendicular to the direction of flow in the conduit channels offset to the conduit channels of the second group. For example, the center line of a conduit channel of the first group/the extension of this center line can be arranged centrally between the center lines of two conduit channels of the second group.

A separator plate usually has at least one through opening for the passage of a fluid, for example a reaction medium or a cooling medium. The through opening can be fluidically connected to an electrochemically active region, for example via a distribution region located between the bead arrangement and the active region. A conduit channel may extend at least in part from a bead arrangement, for example surrounding the through opening, in the direction of the electrochemically active region. Alternatively or additionally, a conduit channel can extend from this bead arrangement in the direction of the through opening. It is therefore advantageous if at least one conduit channel is arranged on a side of the bead arrangement that faces away from the through opening and fluidically connects the bead interior with the electrochemically active region and/or at least one conduit channel is arranged on a side of the bead arrangement that faces the through opening and fluidically connects the through opening and the bead interior with one another.

The conduit channel can merge directly into the through opening; for example, the edge of the separator plate adjacent to the through opening can be raised. However, the conduit channel can also open into the through opening via a balcony, for example a half-bead balcony, which runs parallel or concentrically to the bead arrangement along the edge of the through opening and connects the conduit channels to each other. In the direction away from the passage opening, a medium can also flow directly into the distribution region in a conduit channel, for example via a perforation in the separator plate, or via perforations in a distribution channel, for example a full-bead like distribution channel, which connects several conduit channels. Furthermore, it is possible that a medium must cross not just one, but several, for example two bead arrangements between a through opening and the electrochemically active region. In this case, it is advantageous if a fluidic connection between the bead arrangements is also made via conduit channels. For example, a conduit channel can be used which has two of the sections described above, for example directly one behind the other and optionally in opposite directions, i.e. in particular each has an enlarged base width and a reduced channel roof width at the transition to the bead flanks, while in the intermediate region the base width is narrower compared to the ends facing the bead flanks and the channel roof width is reduced.

Often, one of the groups of conduit channels faces away from the through opening and points from the bead towards an electrochemically active region, while the other of the groups faces away from the electrochemically active region and points towards a through opening. For example, a medium is guided from a through opening through a bead to, or at least in the direction of, the electrochemically active region(s) or vice versa.

In an electrochemical system, for example, coolant can be guided inside a bipolar plate with two separator plates in such a way that it enters the conduit channels of the second group at protrusions of the edge of the through opening and continues to flow along the conduit channels to the bead flank. After crossing the bead, it can enter the conduit channels of the first group on the opposite flank of the bead and reach the electrochemically active region via a distribution region. At the other end of the electrochemically active region, corresponding structures can be flowed through in reverse order, so that the heated coolant is ultimately discharged via a different through opening.

Reaction medium can, for example, enter from a through opening through perforations or protrusions adjacent to or at the edge of the through opening into conduit channels-usually formed in the interior between two separator plates in fuel cell systems-or the at least one conduit channel of the second group. Like the coolant, it can flow in conduit channels of the second group to the bead, cross it and be guided via conduit channels or the at least one conduit channel of the first group in the direction of the electrochemically active region, usually with the interposition of a distribution region. Here, however, unlike in the case of coolant routing, a perforation is provided at the end of at least one conduit channel that faces the electrochemically active region, usually at the end of each conduit channel of the first group, through which the reaction medium can emerge from the interior onto a surface of a separator plate of the bipolar plate that faces away from the other separator plate and can continue to flow on this surface.

The bead arrangement can run in a straight line and/or can be wavy, at least in sections, it can have corners and other changes of direction in its course. A wave-shaped section of the bead arrangement optionally extends over at least two wavelengths that each consist of a wave trough and a wave crest. By way of example, a wave crest or a wave trough can be regarded as the region between neighboring inflection points of the wavy course of the bead. Optionally, at least one of the conduit channels is arranged in the area of an inflection point of the wavy section of the bead arrangement. All of the conduit channels, for example all of the conduit channels of both groups of conduit channels, can also be arranged in a wavy section of the bead arrangement, for example in the area of inflection points.

The separator plate can consist of a metal sheet, for example an aluminum sheet, a steel sheet, a stainless-steel sheet or a titanium sheet. Sheet thicknesses can range from 50 to 150 μm, especially for fuel-cell applications. For other applications, especially electrolyzers, sheet thicknesses of up to 500 μm are also possible. The sheets can be coated at least in sections and/or at least on one side. The bead arrangement and the at least one conduit channel can be formed into the separator plate by hydroforming, deep-drawing and/or embossing, for example stroke and/or roll embossing. They are therefore a direct part of the respective separator plate. While the bead arrangements often have an elastomer-based coating for micro-sealing, at least in sections, at least in the region of their bead roof, the channel surfaces are optionally uncoated.

The present disclosure can be applied particularly advantageously to separator plates that have a bead arrangement, for example a port bead, which is contacted, for example crossed, by other media passages. Such media passages, hereinafter referred to simply as passages, are found for example on bead arrangements that surround through openings in the separator plate and seal them off from the external environment or from other fluid spaces. For example, such conduit channels are often arranged in regions between a wave trough and a wave crest of a bead arrangement running in the direction of extension. These conduit channels lead at least on one side into one of the bead flanks. This also applies for example to support elements that are also regarded as conduit channels and which open into the flanks of the adjacent bead arrangement, for example the flanks of a perimeter bead. The conduit channels can also be offset from each other on both flanks of the bead arrangement in relation to the direction in which the bead extends and thus only be arranged at bead maxima, for example. The number of conduit channels on both bead flanks can also vary in relation to each other. Such conduit channels or support elements lead to a weakening of the bead arrangements in the mouth regions of these sections, which can be compensated for by designing the conduit channels in accordance with the present disclosure.

According to a further aspect, a further separator plate for an electrochemical system is provided. The separator plate comprises a bead arrangement and at least one conduit channel for directing a fluid. The conduit channel connects to the bead arrangement and is fluidically connected to a bead interior of the bead arrangement. The conduit channel also has a channel roof, a channel base and two channel flanks that each extend between the channel roof and the channel base. The conduit channel has a triangular shape at the transition into one flank of the bead arrangement. In this case, the triangular shape of the conduit channel has a channel roof with a maximum channel roof width of 20%, optionally a maximum of 10%, optionally a maximum of 5% of the base width. Slight deviations from a perfect triangular shape, which has a point-shaped “roof”, are therefore permitted. Similar advantages can be achieved with this separator plate as with the separator plate mentioned above. It may be provided that a cross-sectional shape of the conduit channel is constant over at least 60%, for example at least 75% of its length, and is namely triangular.

Features described in relation to the above-mentioned separator plate can be combined with the further separator plate described here, provided that these features do not contradict the features of the further separator plate.

According to a further aspect, a bipolar plate is proposed which contains at least two, for example interconnected, separator plates, of which at least one, but optionally both, are designed as described above, i.e. have at least one corresponding bead arrangement and at least one corresponding conduit channel. The separator plates can be joined by welding, for example by laser welding.

A further aspect relates to an electrochemical system comprising a plurality of the separator plates described above. The separator plates can be designed as individual plates or as bipolar plates. The electrochemical system is for example a fuel cell system, an electrochemical compressor, a flow battery or an electrolyzer. Both in the plate stack of the electrochemical system and in a bipolar plate, because of the series connection of the bead arrangements the evenness of their compression already has a greater effect than in a single separator plate.

A few examples of separator plates according to the present disclosure will be given below. Identical or similar reference signs denote identical or similar elements, and therefore, where applicable, the description of these elements and reference signs will not be repeated. Each of the following examples implements a variety of optional features in addition to the mandatory features of the present disclosure. However, all the non-mandatory features not specified in the independent claims can also be combined, individually or in any combination, with other non-mandatory features of the same example or of one or more other examples.

### BRIEF DESCRIPTION OF THE FIGURES

FIG. 1 shows an electrochemical system.

FIG. 2 shows two bipolar plates and a membrane electrode unit of an electrochemical cell of the electrochemical system from FIG. 1.

FIG. 3 shows a section around a through opening of a separator plate of the bipolar plate from FIG. 2.

FIG. 4 shows a section of a separator plate in the region of several through openings.

FIGS. 5A-5C show a separator plate of the prior art in an oblique view and a top view of the bead arrangement with conduit channels as well as a sectional view corresponding to sections A-A and A′-A′.

FIGS. 6A-6D show a first variant of the separator plate according to the present disclosure in an oblique view and a top view of the bead arrangement with conduit channels as well as sectional views corresponding to sections B-B and B′-B′.

FIGS. 7A-7D show a second variant of the separator plate according to the present disclosure in an oblique view and a top view of the bead arrangement with conduit channels as well as sectional views corresponding to sections C-C and C′-C′.

FIGS. 8A-8C are representations of surface pressures in the region of the beads of three separator plates.

FIGS. 9A-9C are representations of line pressures in the region of the beads of three separator plates.

FIG. 10 shows a third variant of the separator plate according to the present disclosure in a top view of the bead arrangement with conduit channels.

### DETAILED DESCRIPTION

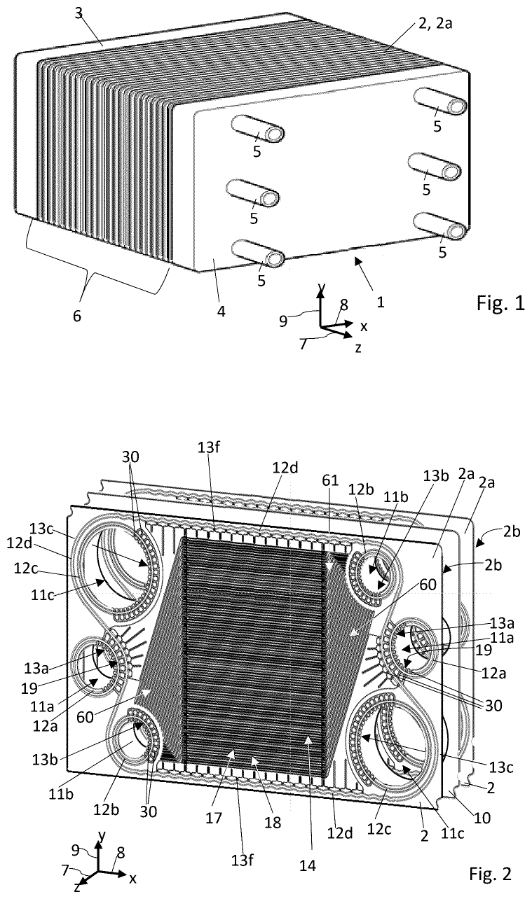

FIG. 1 shows an electrochemical system 1 having a plurality of identical metallic separator plates 2a, which are arranged in a stack 6 and stacked along a z-direction 7. The separator plates 2a of the stack 6 are clamped between two end plates 3, 4. The z-direction 7 is also referred to as the stacking direction. In this example, the system 1 is a fuel cell stack in which two separator plates are joined to form a bipolar plate 2. Two adjacent bipolar plates 2 of the stack define an electrochemical cell, which is used, for example, to convert chemical energy into electrical energy. To form the electrochemical cells of the system 1, a membrane electrode assembly (MEA) 10 is arranged in each case between adjacent bipolar plates 2 of the stack (see, for example, FIG. 2). The MEA 10 contains at least one membrane, e.g. a catalyst-covered electrolyte membrane. Furthermore, a gas diffusion layer (GDL) can be arranged on one or both surfaces of the MEA.

In alternative embodiments, the system 1 can also be designed as an electrolyzer, electrochemical compressor or flow battery. Separator plates or bipolar plates formed from two separator plates can also be used in these electrochemical systems. Their structure can then correspond to the structure of the separator plates 2a and/or bipolar plates 2 described in more detail here, even if the media carried on or through them in an electrolyzer, in an electrochemical compressor or in a flow battery may differ from the media used for a fuel cell system.

Together with an x-axis 8 and a y-axis 9, the z-axis 7 spans a right-handed Cartesian coordinate system. The bipolar plates 2 each define a plate plane at the interface of their separator plates, whereby the plate planes of the separator plates are each aligned parallel to the x-y plane and thus perpendicular to the stacking direction or to the z-axis 7. The end plate 4 generally has a large number of media connections 5 via which media can be supplied to the system 1 and via which media can be discharged from the system 1, whereby the media connections 5 are sometimes referred to as ports. Said media that can be fed to the system 1 and discharged from the system 1 may comprise for example fuels such as molecular hydrogen or methanol, reaction gases such as air or oxygen, reaction products such as water vapor or depleted fuels, or coolants such as water and/or glycol.

FIG. 2 shows, in a perspective view, two adjacent bipolar plates 2, known from the prior art, of an electrochemical system of the same type as the system 1 from FIG. 1, as well as a membrane electrode assembly (MEA) 10, likewise known from the prior art, which is arranged between these adjacent bipolar plates 2, the MEA 10 in FIG. 2 being largely obscured by the bipolar plate 2 facing towards the viewer. The bipolar plate 2 is formed of two separator plates 2a, 2b that are joined in a materially-bonded manner, of which only the first separator plate 2a facing towards the viewer is visible in FIG. 2, said first separator plate obscuring the second separator plate 2b. The separator plates 2a, 2b each comprise at least one metal layer, for example formed of a stainless-steel sheet. Two adjacent separator plates 2a, 2b may for example be welded to one another, e.g. by laser welds.

The separator plates 2a, 2b typically have through openings that are aligned with one another and form through openings 11a-c of the bipolar plate 2. When a plurality of bipolar plates of the same type as the bipolar plate 2 are stacked, the through openings 11a-c form lines which extend through the stack 6 in the stacking direction 7 (see FIG. 1). Typically, each of the lines formed by the through openings 11a-c is fluidically connected to one of the ports 5 in the end plate 4 of the system 1. For example, coolant can be introduced into the stack 6 or discharged from the stack via the lines formed by the through openings 11a. In contrast, the lines formed by the through openings 11b, 11c may be designed to supply fuel and reaction gas to the electrochemical cells of the fuel cell stack 6 of the system 1 and to discharge the reaction products from the stack. The media-guiding through openings 11a-c are substantially parallel to the plate plane.

To seal the through openings 11a-c from the interior of the stack 6 and from the external environment, the first separator plates 2a each have sealing arrangements in the form of bead arrangements 12a-c, which are each arranged around the through openings 11a-c and which completely enclose the through openings 11a-c in each case. The bead arrangements 12a-c surrounding these through openings are also referred to as port beads. The second separator plates 2b, on the rear side of the bipolar plates 2 that faces away from the observer of FIG. 2, have corresponding sealing beads for sealing off the through openings 11a-c (not shown).

In an electrochemically active region 18, the first separator plates 2a have, on the front side thereof facing towards the viewer of FIG. 2, a flow field 17 having first structures 14 for guiding a reaction medium along the outer side (or also front side) of the separator plate 2a. In FIG. 2, these first structures 14 are defined by a plurality of webs and by channels that extend between the webs and are delimited by the webs. On the front side of the bipolar plates 2, that is facing towards the viewer of FIG. 2, the first separator plates 2a additionally each have a distribution or collection region 60. The distribution or collection region 60 comprises structures 61 that are designed to distribute a medium over the active region 18 which medium is introduced into the distribution or collection region 60 from a first of the two through openings 11b, and/or to collect or to pool a medium that is flowing towards the second of the through openings 11b from the active region 18. In FIG. 2, the distributing structures 61 of the distribution or collection region 60 are likewise defined by webs and by channels that extend between the webs and are delimited by the webs.

The bead arrangements 12a-12c have passages 13a-13c, of which the passages 13a are formed both on the lower side of the upper separator plate 2a and on the upper side of the lower separator plate 2b, while the passages 13b are formed in the upper separator plate 2a and the passages 13c in the lower separator plate 2b. For example, the passages 13a allow a passage of coolant between the through opening 11a and the distribution or collection region 60, so that the coolant enters or is led out of the distribution or collection region 60 between the separator plates 2a, 2b.

Furthermore, the passages 13b enable hydrogen to pass between the through opening 11b and the distribution or collection region on the upper side of the upper separator plate 2a; these passages 13b are characterized by perforations facing towards the distribution or collection region and extending at an angle to the plate plane. Therefore, hydrogen for example flows through the passages 13b from the through opening 11b to the distribution or collection region on the upper side of the upper separator plate 2a, or in the opposite direction. The passages 13c enable a passage of air for example between the through opening 11c and the distribution or collection region, so that air reaches the distribution or collection region on the lower side of the lower separator plate 2b and is guided out therefrom. The associated perforations are not visible here.

The first separator plates 2a each also have a further sealing arrangement in the form of a perimeter bead 12d, which extends around the flow field 17 of the active region 18 and also around the distribution or collection region 60 and the through openings 11b, 11c and seals these off with respect to the through openings 11a, that is to say with respect to the coolant circuit, and with respect to the external environment of the system 1. The second separator plates 2b each comprise corresponding perimeter beads 12d. At the through opening 11a, the passage 13a here has three groups of conduit channels 30, one of which extends from the through opening 11a to the interior of the port bead 12a, one from the interior of the port bead 12a to the interior of the perimeter bead 12d and one from the interior of the perimeter bead 12d to the cavity 19 of the distribution region 60. The passages 13b, 13c, on the other hand, only have two groups of conduit channels 30.

Both on the upper and on the lower outer edge, the first separator plates and also the second separator plates (not shown) have support elements 13f adjacent to the perimeter bead 12d and opening into the latter, which in their entirety prevent the fluids on the surfaces of the respective separator plate 2a, 2b that face towards the MEA from flowing into the intermediate space between the perimeter bead 12d and the structures 14 for guiding a reaction medium.

The structures of the active region 18, the distribution or collection structures of the distribution or collection region 60, the bead arrangements 12a-d, the passages 13a-c and the support elements 13f are each formed integrally with or in the separator plates 2a and molded into the separator plates 2a, for example in an embossing, hydroforming or deep-drawing process. The same applies to the corresponding structures of the second separator plates 2b. Each bead arrangement 12a-12d can have, in cross-section, at least one bead roof and two bead flanks, but an essentially angular arrangement between these elements is not necessary; a curved transition can also be provided.

While the bead arrangements 12a-12c are essentially round, the perimeter bead 12d has various sections that are shaped differently. For instance, the course of the perimeter bead 12d may include at least two wavy sections. If, unlike in the present example, the port beads 12a-12c are not circular, it is preferred if these, too, have a wavy course at least in some sections.

The two through openings 11b or the lines through the plate stack of system 1 formed by the through openings 11b are in fluid connection with each other via passages 13b in the bead arrangements 12b, via the distribution structures of the distribution or collection region 60 and via the flow field 17 in the active region 18 of the first separator plates 2a that is facing the viewer of FIG. 2. In an analogous manner, the two through openings 11c and/or the lines formed by the through openings 11c through the plate stack of the system 1 are each in fluid connection with one another via corresponding passages, via corresponding distribution structures and via a corresponding flow field on an outer side of the second separator plates 2b that is facing away from the viewer of FIG. 2. To this end, first structures, for example channel structures, 14 for guiding the relevant media are provided in the active regions 18.

In contrast, the through openings 11a and/or the lines through the plate stack of the system 1 that are formed by the through openings 11a are fluidically connected to one another via a cavity 19 that is enclosed or surrounded by the separator plates 2a, 2b. Each cavity 19 serves to guide a coolant through the bipolar plate 2, in particular to cool the electrochemically active region 18 of the bipolar plate 2. The coolant thus serves primarily to cool the electrochemically active region 18 of the bipolar plate 2. The coolant flows through the cavity 19 from an inlet opening 11a towards an outlet opening 11a. Mixtures of water and antifreeze are often used as coolants. However, other coolants are also conceivable. For better guidance of the coolant or cooling medium, second structures are present on the inner side of the bipolar plate 2. Said second structures are not visible in FIG. 2 since they extend, for example, on the surface of the separator plate 2a that is facing away from the viewer; they are therefore situated opposite the above-mentioned first structures 14 on the other surface of the separator plate 2a. In the active region 18, the second structures guide the cooling medium along the inside of the bipolar plate in the direction of the outlet opening 11a. The second structures typically comprise channel structures for guiding the cooling fluid, which define a longitudinal flow direction of the cooling medium.

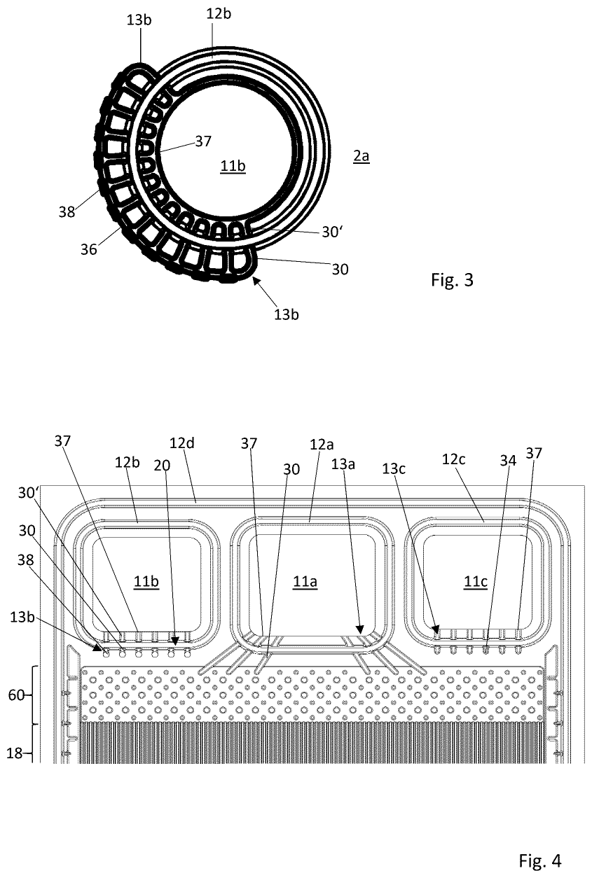

FIG. 3 shows a sectional view of the separator plate 2a in the region of the through opening 11b of the separator plate 2a in FIG. 2. The through opening through the separator plate 2a is completely surrounded by the bead arrangement 12b. This bead arrangement is crossed by bead-shaped passages 13b, only one of which is provided with the reference sign. The conduit channels 30, 30′ of the passage 13b serve to feed the medium in the through opening 11b, here for example H₂, through the bead arrangement 12b. The conduit channel 30′ has a raised portion 37, also referred to as a balcony, at the edge of the through opening 11b, and the conduit channel 30 ends, facing away from the through opening 11b, in a bead-like distribution channel 36, which has a plurality of perforations 38 for fluidic connection of the conduit channel 30 to the distribution region 60.

FIG. 4 shows a top view of a section of an alternative separator plate 2a in the region of the through openings 11a-11c, the distribution region 60 and a small section of the active region 18. Unlike in FIGS. 2 and 3, the through openings 11a-c are essentially rectangular, and the port beads 12a-c also have straight sections. Conduit channels 30, 30′ are again arranged on the port bead 12b. For example, H₂ can be fed from the through opening 11b via a protrusion 37 at its edge into the conduit channel 30′ that faces the through opening 11b to the interior 20 of the bead 12b and from there via the conduit channel 30 to the perforation 38. From this perforation, the medium, e.g. H₂, flows via the distribution region 60, which here has point-shaped support and conduit structures, to the guide structures of the active region 18. This example does not have a distribution channel 36 on the distribution region side.

The other through openings 11a, 11c have comparable passages 13a, 13c, whereby the conduit channels 30′ arranged adjacent to the through opening 11a open into the cavity 19 for guiding a coolant. The conduit channels 30 arranged adjacent to the through opening 11c have a dead end 34 in the separator plate 2a at the end facing the distribution region 60, but perforations comparable to the perforations 38 are present at the corresponding position in the separator plates 2b, which enable a flow of medium from the through opening 11c to the surface of the separator plate 2b that is facing away from the observer (not shown).

In FIGS. 2 to 4 it is shown that through openings can have different shapes, which are associated with different courses of the port beads sealing them. FIGS. 2 to 4 show that the conduit channels 30, 30′ of bead arrangements 12a-d crossing passages 13a-c, on the other hand, differ in previous variants only in whether the conduit channels 30 or 30′ at a through opening are essentially parallel to one another or are inclined to one another (e.g. axially to the center of gravity of the through opening). In the following, conduit channels with an essentially straight course and parallel alignment are considered. The bead arrangements are periodically wavy along their course. However, the following statements can also be applied to other bead courses as well as to groups of conduit channels of a passage that are inclined towards each other, and also to support elements 13f, unless the opposite is explicitly stated.

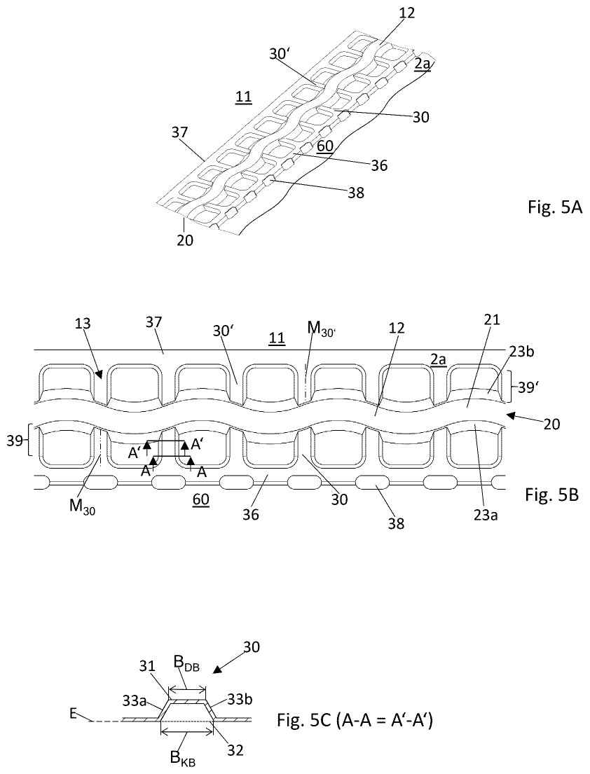

FIGS. 5A-7C show sections of a separator plate 2a for an electrochemical system 1 as shown in FIG. 1. The sections shown each comprise a through opening 11, a bead arrangement 12 and at least two conduit channels 30, 30′ for the passage of a fluid. The through opening 11 can correspond to one of the through openings 11a-c shown above, and the bead arrangement 12 can correspond to one of the bead arrangements 12a-d shown above. Both conduit channels 30, 30′ connect to the bead arrangement 12 and are fluidically connected to a bead interior 20 of the bead arrangement. They each have a channel roof 31, a channel base 32 and two channel flanks 33a, 33b extending between the channel roof and the channel base.

All of the passages 13 shown in FIGS. 5A-7D each have optional protrusions 37 at the edge of the through opening 11, which establish the fluidic connection of the through opening 11 with the conduit channel 30′ facing the through opening. On the side of the bead arrangement 12 that is facing away from the through opening 11, the conduit channel 30 on the distribution region side opens into a distribution channel 36, in which perforations 38 are usually formed, which in turn establish the fluidic connection to the distribution region 60. Both the protrusion 37 and the distribution channel 36 are bead-shaped and run essentially parallel to the bead 12.

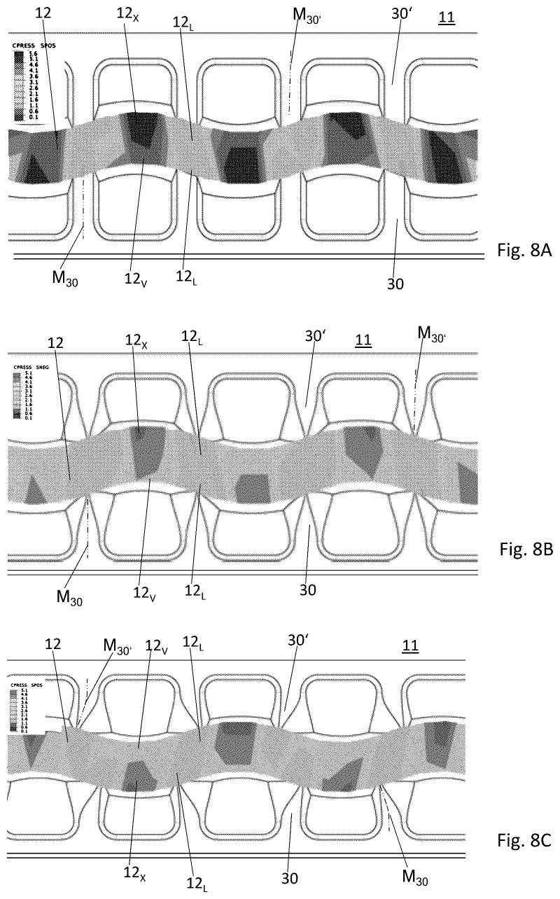

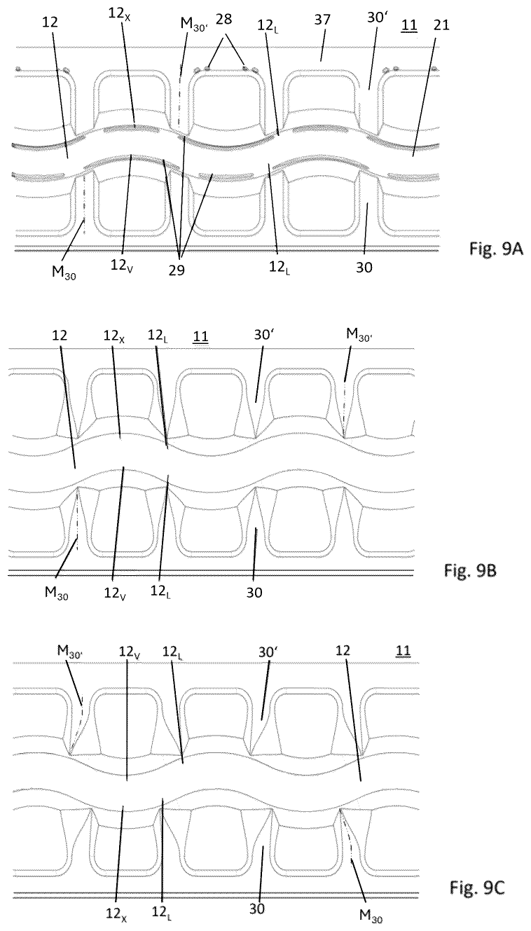

While a straight bead arrangement that has no passages, such as the bead arrangements on the straight upper and lateral edges of the through openings 11a-c in FIG. 4, is characterized by a uniform contact pressure, this changes in the case of beads that have passages, such that the passages intersect the beads over their course. This has an even greater effect with non-straight bead arrangements. This is shown, for example, in FIGS. 8A-8C and 9A-C. FIGS. 8A-8C show the surface compression of the bead surface, FIGS. 9A-9C the line compression of the bead roof in the regions adjacent to the respective bead flanks.

FIGS. 8A and 9A show the compressions for a bead with previously known conduit channels 30, 30′ with a straight and constant cross-section comparable to FIGS. 5A-5C, but without perforations 38. The large color contrasts in FIG. 8A clearly show that the surface compression in the regions 12_{L}, where the bead flanks merge into conduit channels, is significantly lower than in the regions 12_{V}, 12_{X} in between. The differences in surface compression are up to 400%. FIG. 9A shows analogously that the sealing lines on both sides of the bead roof 21 do not continue uninterruptedly at the same compression level, rather they only have a minimum level in the regions 12_{L} in which a conduit channel 30, 30′ opens into a bead flank 33a, 33b. The regions of the minimum level do not extend symmetrically to a center line M₃₀ or M_{30′} of a conduit channel 30, 30′, but the reduction of the line compression has a greater effect on the part of the bead course that is facing away from a convex region 12_{X} of the bead than on a part that is facing a concave region 12_{V} of the bead.

A fuel cell seal usually comprises not only a bead seal, but also has an additional micro-seal. This can consist of or comprise elastomer-based seals, for example foamed elastomer-based seals, such as those known from DE 10 2021 204 497 A1 of the applicant. Such micro-seals can be applied to the bead itself or to the MEA, as described in the above-mentioned document. In this context, the line compression ranges that are reduced to a minimum level are to be understood as meaning that the contact pressure of the bead in the relevant regions is low and a greater proportion of the sealing is provided by the micro-seal. The entire sealing system is also sufficient for sealing the electrochemical system in question in regions where the line compression only reaches the minimum level, but it is also desirable with regard to the service life of the separator plates to equalize the compression.

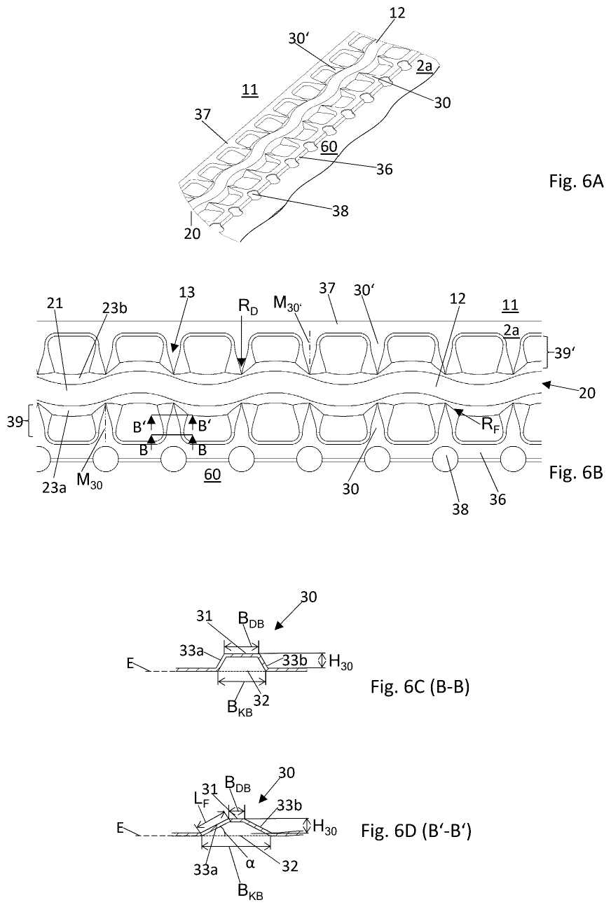

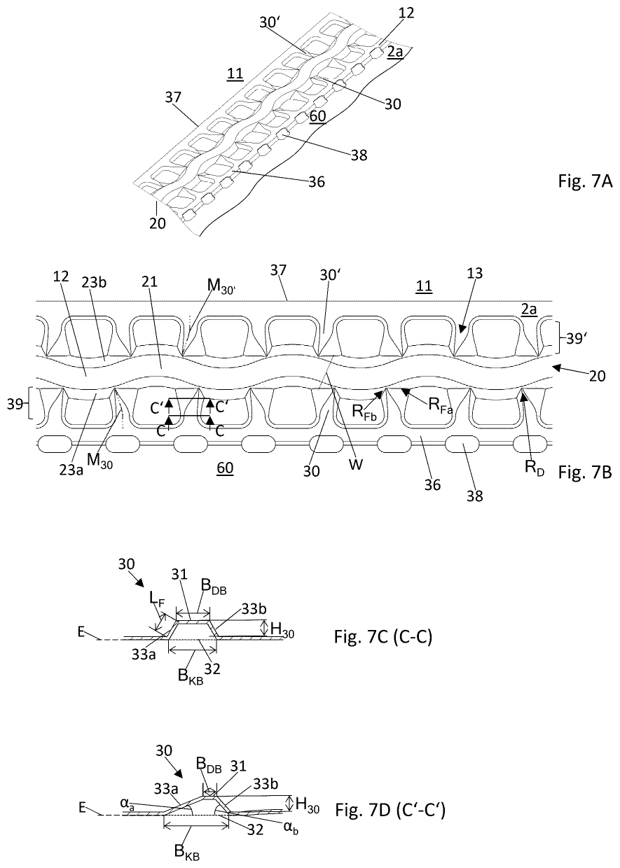

This can be achieved by ensuring that the conduit channels 30, 30′ do not have an essentially constant cross-sectional shape over their entire length, as in FIGS. 5A-5C. Instead, the conduit channels 30, 30′ as shown in FIGS. 6A-6D and FIGS. 7A-7D, are each formed such that the base width B_{KB} of their channel base 32 increases towards the bead arrangement 12, at least in a section 39, 39′ of the respective conduit channel 30, 30′, while the channel roof width B_{DB} of their channel roof 31 decreases towards the bead arrangement 12 in the same section 39, 39′. Both the base width B_{KB} of the channel base 32 and the channel roof width B_{DB} of the channel roof 31 are determined parallel to the separator plate plane E; in the case of a single-layer separator plate, this can be the plane in which the channel base 32 extends; in the case of a bipolar plate 2 with two separator plates, this plane can correspond to the contact plane of the two separator plates 2a, 2b. The section 39 or 39′ ends, on the bead-facing side, in the bead flank 33a or 33b, i.e. usually in a slope, which can mean that the channel roof and the channel base have a different extension length along the section 39, 39′. However, the determination of the channel roof width B_{DB} as well as the base width B_{KB} should optionally not be carried out at this angle, but in orthogonal projection onto the plate plane and onto a perpendicular to the course of the conduit channel 30. The channel roof width and the base width directly at the bead arrangement can therefore be determined orthogonally to the center line M₃₀ of the channel roof 31, which is still to be defined below, at the position in orthogonal projection onto the plate plane at which at least one foot of the conduit channel begins to merge into a foot of the bead in the direction in which the conduit channel runs towards the bead, as shown in FIG. 5B with the position of section A′-A′, in FIG. 6B with the position of section B′-B′ and in FIG. 7B with the position of section C′-C′. On the side that is facing away from the bead, the section 39, 39′ can end at the transition to a distribution channel 36 or to a balcony 37 or in the region of perforations 38.

The bead arrangements of FIGS. 6A-6D and FIGS. 7A-7D do not show a uniform compression pattern either, but both the surface compression and the line compression are much more uniform, as can be seen from FIGS. 8B-8C and 9B-9C. The highest surface compressions achieved are lower in FIGS. 8B-8C; the extremely dark coloration in FIG. 8A does not occur. In FIG. 8C, no region can be seen that has such a low surface compression as the regions of lowest surface compression in FIGS. 8A and 8B. Furthermore, both the proportions of the darkest regions of the highest surface compression—in FIGS. 8B-8C—and the lightest regions of the lowest surface compression—in FIG. 8B—a re much less pronounced than in FIG. 8A. In the case of the line compressions, both FIG. 9A and FIGS. 9B-9C show a lowering to a minimum level, so that in these regions a larger proportion of the sealing takes place via the micro-sealing. However, FIGS. 9B-9C do not show any regions of particularly high line compression 29 in close proximity to the regions of the minimum level, so that at least no such sharp drop in pressure occurs there as is the case in the example with conventional conduit channel 30, 30′ of FIG. 9A. Furthermore, in the embodiment examples of FIGS. 6A-6D and 7A-7D, i.e. in FIGS. 9B and 9C, the regions of local overcompression 28 in the region of the protrusion 37, which are clear from FIG. 9A, are no longer present.

From FIGS. 6B and 7B it is clear that the respective channel roofs 31 have their smallest channel roof width B_{DB,min} min directly at the bead arrangement 12. In both examples, the width is infinitesimally small and essentially results from the radius R_{D} with which the channel flank 33a merges into the channel flank 33b. The radius R_{D} can be between 0.1 mm and 0.4 mm, for example. The cross-sectional shape of the conduit channel 30 directly at the bead arrangement is correspondingly essentially triangular. Directly at the bead arrangement 12, the channel roof width B_{DB} or B_{DB,min} min has a ratio to the base w_{KB}th BKB of less than 0.2. In the region of the intersection line B′-B′ in FIG. 6D it is 0.23, at the intersection line C′-C′ in FIG. 7D it is exactly 0.2. At the ends of the conduit channels 30 that face away from the bead, the cross-sectional shape of the conduit channel is essentially trapezoidal and the ratio of B_{DB} to B_{KB} there is approximately 0.72 in the present examples, i.e. at the intersection lines B-B in FIG. 6C and C-C in FIG. 7C. This ratio corresponds approximately to that of the conventional conduit channel in FIG. 5C, which is approximately 0.70, see FIG. 5C.

The channel flanks 33a, 33b have the same flank length L_{F} directly at the bead arrangement in FIG. 6D, whereas the flank length of the channel flank 33b in FIG. 7D is only approx. 60% of the length of the channel flank 33a. The height H₃₀ of the conduit channel 30,30′ and/or the distance of the channel roof 31 from the channel base 32 measured perpendicular to the separator plate plane E may remain substantially the same in the said section, as shown in FIGS. 6C-6D as well as in FIGS. 7C-7D. The flank angles α of the two channel flanks 33a, 33b measured relative to the separator plate plane E are the same in FIG. 6D and amount to slightly more than 30°. The flank angles αₐ and α_{b} of the two channel flanks 33a, 33b in FIG. 7D, on the other hand, differ significantly from each other at 12° and 47° respectively.

The conduit channels 30/30′ shown in FIGS. 6A-6B/7A-7B, respectively, are arranged in groups on either side of the bead arrangement 12. For example, the group of conduit channels 30 that face away from the through opening 11 can be regarded as the first group and the group of conduit channels 30′ that face the through opening 11 can be regarded as the second group. The groups are therefore arranged on opposite sides of the bead arrangement. Within a group of conduit channels 30 or 30′, the center lines M₃₀, M₃₀′ of the channel roofs 31 of at least two conduit channels 30 or 30′ and/or of a group can run straight and parallel to each other, as shown in FIGS. 6A-6B show. In FIGS. 7A-7B, on the other hand, the center lines M₃₀, M_{30′} of the channel roofs 31 of the conduit channels 30 and 30′, respectively, are curved in such a way that the conduit channels closest to each other each have an opposing curvature and approach each other (adjacent to a convex bead section) or diverge from each other (adjacent to a concave bead section) towards the bead flank 23a and 23b, respectively. Accordingly, the center lines M₃₀, M_{30′} of the channel roofs 31 of a group of conduit channels 30/30′ run non-parallel to each other.

Also, individual conduit channels cannot be aligned parallel to each other as in FIGS. 6A-6D, if they are used to guide the media through a bead arrangement that does not run in a straight line with respect to its main direction of extension, but is arranged, for example, at an oval or round through opening as in FIG. 3 and follows its contour. The center lines of the channel roofs of the conduit channels can then extend along axes that run through the center of the through opening, for example.

The transition from a channel flank 33a, 33b to a bead flank 23a, 23b spans a radius R_{F}. In the examples of FIGS. 6B and 7B, a uniform radius extends from the edge of the channel base 32 to the edge of the channel roof 31. Here it even runs along/around the channel roof 31 and is approx. 0.2 mm. In the example in FIG. 7B, the radii R_{Fa}, R_{Fb} are also identical on both channel flanks 33a, 33b.

Even if the cross-sectional geometries change over the course of the conduit channels 30, 30′ in section 39, 39′, the size of the flow cross-section of the conduit channel 30 and/or 30′ in section 39, 39′ may remain essentially the same. This ensures that the pressure drop over the course of the conduit channels remains minimal.

Also in view to the forming of the separator plate 2a, it is advantageous if the channel roof 31 of the at least one conduit channel 30, 30′, and optionally of all conduit channels 30, 30′, is flat and extends parallel to the separator plate plane E of the separator plate 2a. The bead roof 21 of the bead arrangement 12 can also be flat and extend parallel to the separator plate plane E of the separator plate 2a. However, the bead roof 21 can also be cambered or wavy in its cross-section perpendicular to the main direction of extension of the bead arrangement 12, which allows more degrees of freedom, particularly with regard to the spring properties of the bead arrangement 12. Optionally, the regions of each cross-section which regions protrude the most from the separator plate plane E also run parallel to the separator plate plane along the course of the bead arrangement 12. A cambered or wavy bead roof 21 can also be combined with flat channel roofs 31. With regard to the compression of the bead arrangement 12, it is advantageous if the height of the bead arrangement 12 is higher than a height H₃₀ of the conduit channel 30, 30′. The roof of the bead arrangement 12 often forms the highest protrusion of the separator plate 2a, 2b measured from the plate plane E.

The bead arrangement 12 extends both in FIG. 6A-6B as well as in FIGS. 7A-7B, at least in sections, in a wavy manner; specifically, the section of the bead arrangement 12 shown there extends in a wavy manner and in each case extends over at least two wavelengths. The conduit channels 30, 30′ each open into the region of an inflection point of the wavy section of the bead arrangement 12.

As already mentioned, the conduit channels 30 are arranged as a first group and the conduit channels 30′ as a second group of conduit channels on both sides of the bead arrangement 12. The conduit channels 30 of the first group and the conduit channels 30′ of the second group are shown aligned to one another in FIGS. 6A-6B in the direction of flow of the fluid transverse to the bead arrangement 12. In FIGS. 7A-7B, the conduit channels 30 and the conduit channels 30′ are only aligned with each other in the region of their channel bases 32, whereas in the region of the channel roofs 31 they are offset from each other perpendicular to the direction of flow. The channel roofs 31 on both sides of a line W, open into the bead flanks 23a, 23b whereby the line W connects the inflection points of the wavy transitions between the flanks 23a, 23b and the roof 21. In principle, it is also possible for the conduit channels of the first group to be arranged completely offset to the conduit channels of the second group perpendicular to the direction of flow.

In FIGS. 6A-6B and 7A-7B, respectively, a through opening 11 for passing the fluid and a distribution region 60 are shown. Analogous to FIGS. 2 and 4, in the examples of FIGS. 6A-6B and 7A-7B, an electrochemically active region 18, which is not explicitly shown there, adjoins the distribution region 60. In FIGS. 6A-6B and 7A-7B, a plurality of conduit channels 30′ extend, at least in regions, from the bead arrangement 12 in the direction of the through opening 11. Likewise, a plurality of conduit channels 30 extend, at least in regions, from the bead arrangement 12 in the direction of the distribution region 60 and further in the direction of the (not shown) electrochemically active region. Here, the conduit channels 30 are arranged on a side of the bead arrangement 12 that is facing away from the through opening 11 and fluidically connect the bead interior 20 with the electrochemically active region 18. The conduit channels 30′, on the other hand, are arranged on the side of the bead arrangement 12 that is facing the through opening 11 and fluidically connect the through opening 11 and the bead interior 20.

In FIGS. 6A-6B and 7A-7B, both the conduit channels 30 of the first group and the conduit channels 30′ of the second group extend, at least in regions, perpendicular to a main extension direction of the bead arrangement 12. In the example of FIGS. 7A-7B, at least the bases 32 of the conduit channels 30, 30′ extend perpendicular to the main direction of extension of the bead arrangement 12.

During the manufacture of the separator plate 2a, the bead arrangement 12 and the conduit channels 30, 30′ can be formed into the separator plate 2a by hydroforming, deep-drawing and/or embossing, for example stroke and/or roll embossing. A separator plate 2a produced in this way, which comprises a bead arrangement 12 and a conduit channel 30, 30′, can be combined with a second, identical or essentially identical separator plate 2b to form a bipolar plate 2, as shown in FIG. 2. The separator plates can be joined using laser welding, for example.

A plurality of the separator plates 2a that are shown in more detail in FIGS. 6A-7D can be stacked as such or connected to another separator plate 2b as bipolar plates 2 together with corresponding MEAs in an electrochemical system comparable to the electrochemical system 1 of FIG. 1. Such an electrochemical system can be, for example, a fuel cell system, an electrochemical compressor, a flow battery or an electrolyzer.

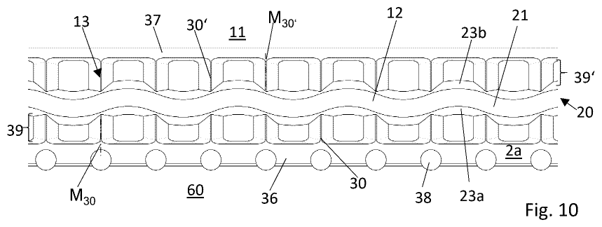

A further variant of a separator plate 2a according to the present application is shown in FIG. 10.

The separator plate 2a of FIG. 10 comprises a bead arrangement 12 and a plurality of conduit channels 30, 30′ for directing a fluid. The conduit channels 30, 30′ connect to the bead arrangement on both sides of the bead arrangement 12 and are fluidically connected to a bead interior 20 of the bead arrangement 12. Similar to the embodiments described above, the conduit channels 30, 30′ each have a channel roof 31, a channel base 32 and two channel flanks 33a, 33b extending between the channel roof and the channel base. Each conduit channel 30, 30′ has a substantially triangular shape at the transition into a flank 23a, 23b of the bead arrangement 12, wherein the triangular shape of the conduit channels 30, 30′ has a channel roof 31 with a channel roof width of at most 20%, optionally at most 10%, optionally at most 5% of the base width. Deviating from the embodiments of figure groups 6 and 7, the cross-sectional shape of the conduit channel 30, 30′ is constant over at least 60%, optionally at least 75% of its length, namely triangular.

### LIST OF REFERENCE SIGNS

1 electrochemical system
2a, 2b metallic separator plates
2 bipolar plate
3 end plate
4 end plate
5 media connection, port
6 stack
7 z-axis
8 x-axis
9 y-axis
10 MEA
11 through openings
12a-c sealing beads, port beads
12d sealing bead, perimeter bead
12_{L} section of the sealing bead with merging conduit channel
12_{V} concave section of the sealing bead
12_{X} convex section of the sealing bead
13a-c passages
13f support element
14 first fluid guide structures in the electrochemically active region
17 flow field in the active region
18 electrochemically active region
19 cavity
20 bead interior
21 bead roof
23a, 23b bead flanks
28 regions of local high compression
29 regions of very high line compression
30, 30′ conduit channel
31 channel roof
32 channel base
33a, 33b channel flank
34 dead end
36 distribution channel
37 protrusion, balcony
38 perforation
39, 39′ section of the conduit channel
60 distribution or collection region
61 distribution structures for media distribution
B_{KB} base width of the channel base
B_{DB} channel roof width of the channel roof
E plate plane
H₃₀ height of a conduit channel
M₃₀, M₃₀′ centerline of a conduit channel
RD radius of the channel roof when entering the bead flank
R_{F}, R_{Fa}, R_{Fb} transition radius channel flank-bead flank
W connecting line of the inflection points

1. A separator plate for an electrochemical system, comprising a bead arrangement and at least one conduit channel for directing a fluid,
wherein the conduit channel connects to the bead arrangement and is fluidically connected to a bead interior of the bead arrangement, and has a channel roof, a channel base and two channel flanks extending between the channel roof and the channel base, and
wherein a base width of the channel base, determined parallel to the plane of the separator plate, increases towards the bead arrangement at least in a section of the conduit channel, while a channel roof width of the channel roof, determined parallel to the plane of the separator plate, decreases towards the bead arrangement in said section, so that a cross-sectional shape of the conduit channel changes.

2. The separator plate according to claim 1, wherein the channel roof has its smallest channel roof width directly at the bead arrangement.

3. The separator plate according to claim 1, wherein a ratio of channel roof width to base width directly at the bead arrangement is smaller than 0.2.

4. The separator plate according to claim 1, wherein the cross-sectional shape of the conduit channel is substantially triangular directly at the bead arrangement, and wherein the cross-sectional shape of the conduit channel is substantially trapezoidal in a region of the conduit channel spaced from the bead arrangement and in said section.

5. The separator plate according to claim 1, wherein a flank length of each of the channel flanks directly at the bead arrangement is equal or is different.

6. The separator plate according to claim 1, wherein flank angles of the two channel flanks measured relative to the separator plate plane directly at the bead arrangement are different or are equal.

7. The separator plate according to claim 1, wherein center lines of the channel roofs of at least two conduit channels run parallel or non-parallel to each other.

8. The separator plate according to claim 1, wherein center lines of the channel roofs of at least two conduit channels have a curved course or a straight course.

9. The separator plate according to claim 1, wherein a size of a flow cross-section of the conduit channel in said section remains substantially the same.

10. The separator plate according to claim 1, wherein a height of the conduit channel remains substantially the same in said section, wherein the height is a distance between the channel roof and the channel base measured perpendicular to the separator plate plane.

11. The separator plate according to claim 1, wherein the channel roof of the conduit channel is flat and extends parallel to the plane of the separator plate, and/or wherein a bead roof of the bead arrangement is flat and extends parallel to the plane of the separator plate.

12. The separator plate according to claim 1, wherein a height of the bead arrangement is greater than a height of the conduit channel.

13. The separator plate according to claim 1, comprising a first group of conduit channels and a second group of conduit channels, which are arranged on opposite sides of the bead arrangement.

14. The separator plate according to claim 13, wherein the first group and the second group of conduit channels are arranged in alignment with one another in the direction of flow of the fluid or wherein the conduit channels of the first group are arranged offset perpendicular to the direction of flow relative to the conduit channels of the second group.

15. The separator plate according to claim 1, comprising a through opening for directing the fluid and an electrochemically active region, wherein the conduit channel extends, at least in some regions, from the bead arrangement in the direction of the electrochemically active region or in the direction of the through opening.

16. The separator plate according to claim 1, wherein the conduit channel extends, at least in some regions, perpendicular to a main direction of extension of the bead arrangement.

17. The separator plate according to claim 1, wherein the bead arrangement extends in a wave-like manner, at least in sections, wherein at least one section of the bead arrangement that extends in the wave-like manner extends over at least two wavelengths.

18. The separator plate according to claim 17, wherein the conduit channel is arranged in the area of an inflection point of the wave-like section of the bead arrangement.

19. A bipolar plate comprising two interconnected separator plates according to claim 1, wherein the bead arrangement and the conduit channel are formed in at least one of the separator plates.

20. An electrochemical system, comprising a plurality of stacked separator plates according to claim 1, wherein the electrochemical system is a fuel cell system, an electro-chemical compressor, a flow battery, or an electrolyzer.
